(19) United States
(12) Patent Application Publication
(10) Pub. No.: US 2009/0117866 A1
(43) Pub. Date: May 7, 2009

(54) Tuning of Radio Receivers

(76) Inventor: Nicholas Richard James Opperman, Hampshire (GB)

Correspondence Address: Nguyen & Tarbet, 6039 E. Grant Rd., Tucson, AZ, 85712, US

(21) Appl. No.: 12/280,527

(22) PCT Filed: Feb. 26, 2007
(86) PCT No.: PCT/GB2007/000631

§ 371 Date: Aug. 22, 2008

(30) Foreign Application Priority Data
Feb. 24, 2006 (GB) 0603807.9

(51) Int. Cl. H04B 1/18

(52) U.S. Cl. 455/185.1

(57) ABSTRACT

A radio receiver (10) can be tuned selectably in a first mode to radio stations broadcasting in the 87.5 to 108.0 MHz FM2 band and in a second mode to event radio broadcasts on preset frequencies at least one of which is outside that band. A pair of push-buttons (20,22) can be operated to change the reception frequency to which the receiver is tuned. When the first mode is selected, the push-buttons can be used to tune the receiver to any desired frequency in the FM band and/or to the frequency of any desired signal being received in the FM band. When the second mode is selected, the push-buttons can be used to tune the receiver only to any one of the preset event radio frequencies. When the user wishes to change between listening to a broadcast in the FM band and listening to an event radio broadcast outside the first band, they therefore do not need to scan between the event radio frequency and the frequency of the other broadcast. Also, the user cannot tune the receiver to frequencies (which may be prohibited frequencies) between the event radio frequency and the FM2 band. The receiver is in a housing (12) that can be worn on the user's ear, and has a lanyard (118) that also forms an aerial and that is releasably connected to the housing (12).

This invention relates to radio receivers and in particular to the tuning of radio receivers. The invention was conceived for use with radio receivers intended for receiving “event radio”, but it may have other applications.

Event radio began as the radio broadcasting of a commentary or other audio information at a sports event so that spectators at the event can receive that information. As a result, a spectator can receive expert commentary and information regarding the event they are quite probably paying to watch and is no longer discriminated against when compared to a TV viewer. Some event types lend themselves to event radio more obviously than others, such as:

those where much of the action takes place out of sight of the spectator (e.g. motorsports, three-day eventing, golf, yachting etc.);

those where traditional public address is difficult due to ambient noise or distance (e.g. airshows etc.);

those where traditional public address is simply not acceptable (e.g. golf, cricket, snooker etc.);

those where the spectators can see the action, but want to know what is going on at associated events (e.g. rugby and football league matches); and

those where expensive displays, such as TV monitors or “jumbotrons”, are currently available to spectators but without an audio stream (e.g. horse racing, rugby and football league matches etc.).

Event radio has also been employed to assist those who are hard of hearing, for example in the theatre.

A radio receiver for receiving event radio is disclosed in patent document GB2381397A. It is a natty little device having a housing and a hooked element that enables the housing to be worn on the user's ear. The housing contains a battery, radio receiver circuit, speaker, volume control and on-off switch. An antenna for the receiver circuit is contained in a lanyard connected to the housing to enable the user to hang the device around their neck when they are not listening to it. In an early commercially-produced version of the device, the radio receiver was tuned to a preset reception frequency. In a later version of the device, the user can change the reception frequency by pressing a “scan” button on the housing. Upon pressing the button, the device scans from the current reception frequency through the reception band until the next strong signal is received. The device can therefore advantageously be used at different events to receive event radio being broadcast on different frequencies and can also be used to receive the broadcasts from any other radio stations broadcasting in the particular band.

In the United Kingdom and many other countries, commercial FM radio is broadcast in the 87.5 to 108.0 MHz FM2 band, and event radio has traditionally used the same band. However, other frequencies have more recently been made available for use by event radio and disabled assisted listening, such as frequencies in the 60 to 62 MHz spectrum and in the 72 to 76 MHz spectrum.

In accordance a first aspect of the present invention, there is provided a radio receiver having means operable by a user to change the reception frequency to which the receiver is tuned and having first and second modes of operation, selectable by the user. The receiver is arranged so that at least immediately after the first mode is selected, the frequency changing means is operable in a particular way by the user to tune the receiver to any desired frequency in a first band of reception frequencies (e.g. the 87.5 to 108.0 MHz band) and/or to the frequency of any desired signal being received in the first band of frequencies. However, at least immediately after the second mode is selected, the receiver is tuned to a preset frequency outside of the first band and operation of the frequency changing means in the particular way is ineffective.

This aspect of the invention is suitable for use where the receiver is intended to receive event radio on only one frequency outside of the first band. This aspect of the invention has the advantage that, when the user wishes to change between listening to a broadcast in the first band and listening to the event radio broadcast outside the first band, the user does not need to scan the tuning of the radio between the event radio frequency and the frequency of the other broadcast, something that could take a considerable time when changing for example from 60.0 to 108.0 MHz.

Preferably, when the second mode is selected, the receiver cannot be tuned by the user to any frequency other than the preset frequency. This has the advantage that the user cannot tune the receiver to frequencies (which may be prohibited frequencies) between the event radio frequency and the first band.

In accordance with a second aspect of the invention, there is provided a radio receiver that is similar to the receiver of the first aspect of the invention, except that, at least immediately after the second mode is selected, the frequency changing means is operable in the particular way to tune the receiver only to any one of a plurality of preset frequencies at least one of which is outside of the first band.

This aspect of the invention is suitable for use where the receiver is intended to receive event radio on at least two frequencies (at least one of which is outside of the first band). Again, this aspect of the invention has the advantage that, when the user wishes to change between listening to a broadcast in the first band and listening to the event radio broadcast outside the first band, the user does not need to scan the tuning of the radio between the event radio frequency and the frequency of the other broadcast.

Preferably, when the second mode is selected, the receiver cannot be tuned by the user to any frequency other than one of the plurality of preset frequencies. Again, this has the advantage that the user cannot tune the receiver to frequencies (which may be prohibited frequencies) between the event radio frequency and the first band.

Preferably, when the second mode is selected, the receiver cannot be tuned by the user to at least one of the preset frequencies in accordance with an indication stored by the receiver. For example, if the receiver has the facility to store, say, eight preset frequencies but only, say, five of them are to be used, the receiver may also store an indication that only the first five preset frequencies are to be used, or three of the preset frequencies may be set to a particular value (e.g. 0.00 MHz), and the receiver will operate to prevent tuning to the last three preset frequencies, or to the preset frequencies having the particular value.

The frequency changing means preferably comprises first and second elements (e.g. push-buttons) operable by the user, such that: the first element is operable when the first mode is selected to increase the reception frequency in the first band (e.g. by scanning and/or frequency-stepping); the second element is operable when the first mode is selected to decrease the reception frequency in the first band (e.g. by scanning and/or frequency-stepping); the first element is operable when the second mode is selected to change the selection of preset frequency in one way (e.g. in the case of three preset event radio frequencies, from the first preset frequency to the second, and then from the second preset frequency to the third); and the second element is operable when the second mode is selected to change the selection of preset frequency in a different way (e.g. from the first preset frequency to the third, and then from the third preset frequency to the second). In this case, the selected mode can preferably changed by the user by operating both elements simultaneously. Accordingly, using only two buttons, it is possible to change between the two modes and to tune the receiver in the current mode.

With either aspect of the invention, the receiver is preferably arranged so that, when the receiver is initially switched on, the second mode is initially selected. Event radio receivers are often sold, or given away, at events where event radio is being broadcast, and therefore all the user has to do is to switch on the receiver to receive event radio, without having to worry about mode selection. In the case of the second aspect of the invention, the receiver is preferably arranged so that, when the receiver is initially switched on, the receiver is initially tuned to a preset or predetermined one of the preset frequencies, which is preferably the frequency of the broadcast for the event for which the receiver is acquired. The receiver is preferably also arranged so that, when at least one of the modes is re-selected, the receiver is initially tuned to the frequency to which it was tuned when that mode was last selected. If this feature is provided for both bands, and if, during a break during an event, a user tunes in the first mode to their favourite radio station, when they subsequently select the second mode at the end of the break, the receiver will automatically tune to the relevant event radio broadcast. If, during a subsequent break, the user selects the first mode again, the receiver will automatically tune to the user's favourite radio station.

In order to prevent distorted output from the receiver, when the second mode is selected, the receiver may be operable to disable its output when a received signal has a signal strength less than a preset threshold.

When the second mode is selected, the receiver may be operable to disable its output when a received signal does not include a particular code. Therefore, if an event radio broadcaster adds the particular code to the event radio signals that they broadcast, this feature prevents the receiver being used to receive event radio broadcast by a different broadcaster who does not add the particular code to their broadcasts.

In the manner suggested in patent document GB2381397A, the radio receiver is preferably provided by a radio receiver circuit having an aerial input and a speaker output, wherein: the circuit is contained in a housing; a hooked element extends from the housing for hanging the housing on a user's ear; a speaker is contained in the housing and connected to the speaker output of the receiver circuit for directing sound at the user's ear when the housing is worn on the user's ear; a lanyard extends from the housing by which the user can hold the receiver and/or hang the receiver around their neck; and the lanyard forms or contains an aerial connected to the aerial input of the receiver circuit.

The lanyard provides a useful advertising tool, since it can be printed or interwoven with advertising material relevant to the event for which the radio receiver is being supplied. However, a problem arises in that assembly of a particular batch of receivers typically has to wait until the lanyards have been produced, and that takes time. Furthermore, if some of the receivers that have been produced for a particular event are not used, they then either need to be scrapped, or taken apart and fitted with different lanyards for a subsequent event. This is wasteful of time and/or resources.

The lanyard and aerial are therefore preferably mechanically connected to the housing and electrically connected to the aerial input by a releasable connection so that that lanyard and aerial can be removed from the housing and replaced by a different lanyard and aerial.

This feature may be provided independently of the other aspects of the invention discussed above. Therefore, in accordance with a third aspect of the present invention, there is provided a radio receiver comprising: a housing; a hooked element extending from the housing for hanging the housing on a user's ear; a radio receiver circuit contained in the housing and having an aerial input and a speaker output; a speaker contained in the housing and connected to the speaker output of the receiver circuit for directing sound at the user's ear when the housing is worn on the user's ear; and a lanyard extending from the housing by which the user can hold the receiver and/or hang the receiver around their neck; wherein: the lanyard forms or contains an aerial connected to the aerial input of the receiver circuit; and the lanyard and aerial are mechanically connected to the housing and electrically connected to the aerial input by a releasable connection so that that lanyard and aerial can be removed from the housing and replaced by a different lanyard and aerial.

Specific embodiments of the present invention will now be described, purely by way of example, with reference to the accompanying drawings, in which:

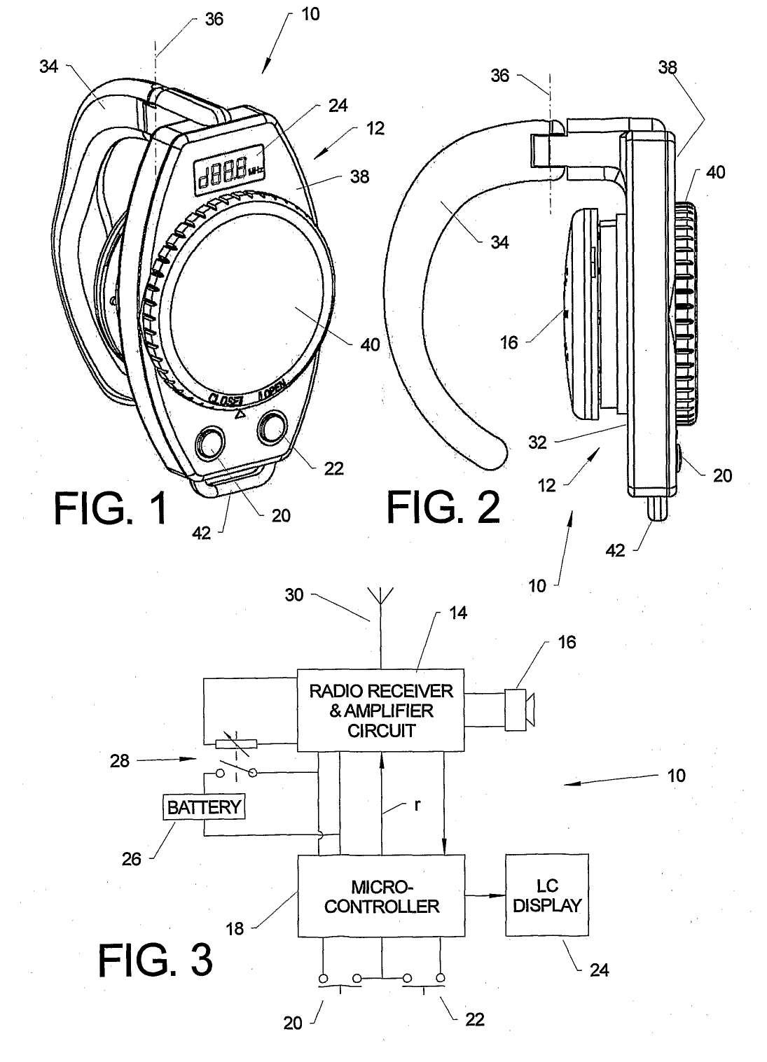

FIG. 1 is a perspective view of a radio receiver of a first embodiment of the invention;

FIG. 2 is a side view of the receiver of FIG. 1;

FIG. 3 is an electrical block diagram of the receiver of FIG. 1;

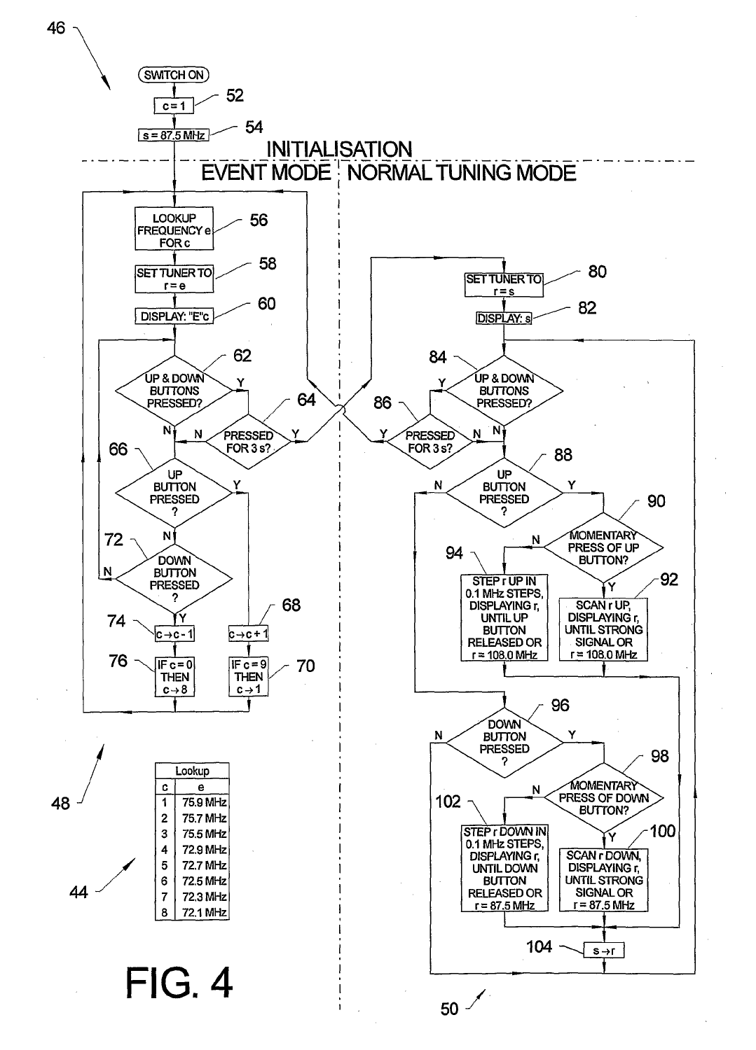

FIG. 4 is a flow diagram of the operation of a microcontroller in the receiver of FIG. 1;

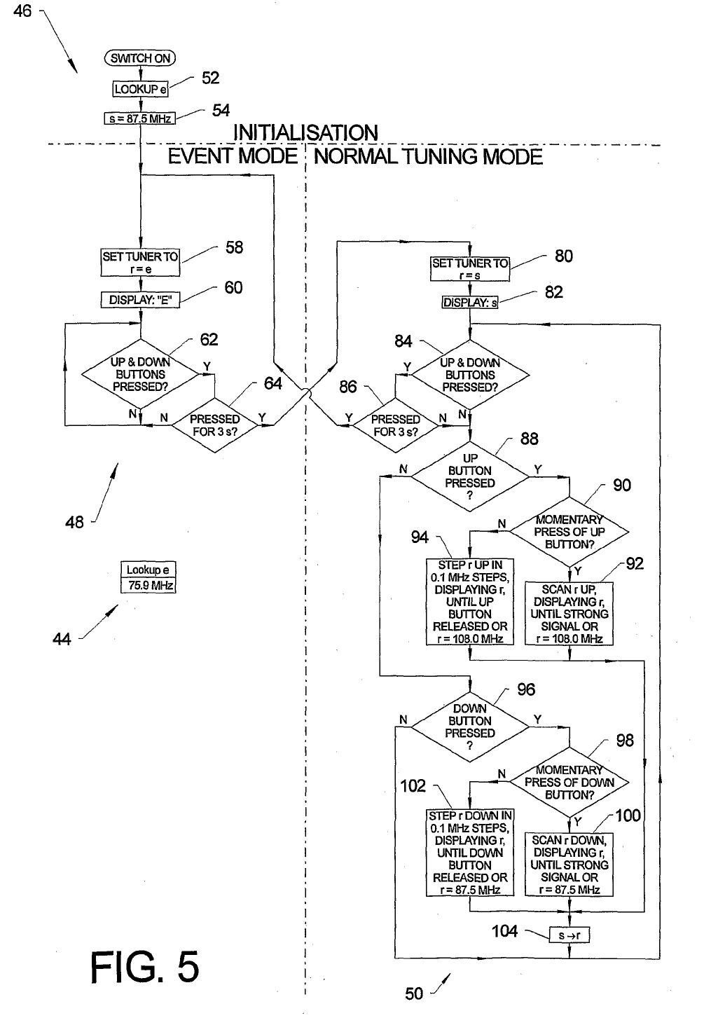

FIGS. 5 & 6 are flow diagrams of modified operations of the microcontroller in the receiver of FIG. 1;

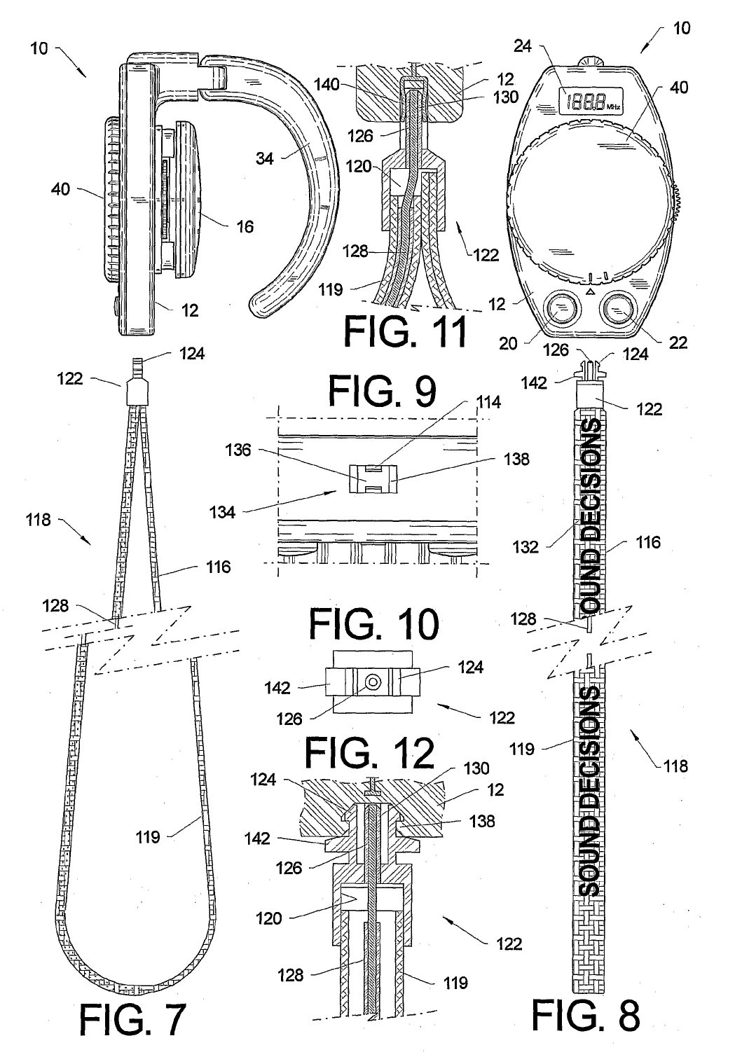

FIG. 7 is a side view of a radio receiver of a second embodiment of the invention, with its lanyard detached;

FIG. 8 is a front view of the radio receiver of FIG. 7;

FIG. 9 is a partial underplan view, on a larger scale, of the receiver of FIG. 7, with its lanyard removed;

FIG. 10 is an end view of a connector of the lanyard of the radio receiver of FIG. 7;

FIG. 11 is a partial sectioned side view of the receiver of FIG. 7, with its lanyard attached; and

FIG. 12 is a partial sectioned front view of the receiver of FIG. 7, with its lanyard attached.

Referring to FIGS. 1 to 3, the first embodiment of radio receiver 10 that is intended to be used with the receiver 10 worn on a user's ear comprises:

a housing 12 containing:
a radio receiver and amplifier circuit 14 which can receive audio radio in the frequency range 60.0 to 108.0 MHz and is tunable in 0.1 MHz steps;
a speaker 16 connected to the output of the circuit 14;
a microcontroller 18 for setting the reception frequency of the circuit 14 and detecting the signal strength of the received signal;
a pair of user operable push-button switches 20,22 for controlling the microcontroller 18, one of the switches 20 being designated an “up” switch, and the other 22 a “down” switch;
a liquid crystal display 24 for displaying the reception frequency or channel of the circuit 14;
a button-cell battery 26 for powering the circuitry in the housing 12; and
a combined on-off switch and potentiometer 28 for switching the receiver 10 on and off and for setting the output volume of the speaker 16; and

an antenna 30 for the circuit 14.

The majority of the circuitry of the radio receiver and amplifier circuit 14 and microcontroller 18 is preferably implemented using a single application specific integrated circuit (ASIC).

The speaker 16 faces out from a rear face 32 of the housing 12 and may be covered by a foam rubber cover (not shown). A hooked element 34 is hinged to the top of the rear face 32 of the housing 12 and can be pivoted about an axis 36 between one position in which the receiver 10 can be worn on the user's right ear with the speaker 16 facing the right ear and the hooked element hooked over the top of the right ear and extending down the back of the ear, and an opposite position in which the receiver 10 can be worn on the user's left ear with the speaker 16 facing the left ear and the hooked element hooked over the top of the left ear and extending down the back of the ear. A central portion of a front face 38 of the housing 12 is provided by a removable cover 40 to provide access to the battery 26. The liquid crystal display 24 is disposed above the battery cover 40, and the push-buttons of the switches 20,22 are disposed beneath the battery cover. The combined switch and potentiometer 28 has a thumbwheel that is accessible through one edge of the housing 12 (but is not in view in FIGS. 1 and 2). The antenna 30 is provided in a lanyard (not shown) that is attached to a lug 42 on the bottom edge of the housing 12. Further description of the lanyard antenna can be found in patent document GB2381397A.

The microcontroller 18 includes a processor, working memory and non-volatile memory. The non-volatile memory stores the operating program of the microcontroller 18 and also preset event radio reception frequencies which can be considered to be in the form of a lookup table 44 (FIG. 4). The microcontroller 18 receives user input from the switches 20,22 and supplies an output r to the radio receiver and amplifier circuit 14 indicative of the required reception frequency to which the circuit 14 is to be tuned.

The operation of the microcontroller 18 will now be described with reference to FIG. 4. The flow diagram of FIG. 4 has three portions:

an initialisation portion 46 which is processed when the receiver 10 is first switched on;

an event mode portion 48 which is processed immediately after the initialisation portion 46 and which defines the operation of the microcontroller 18 when in “event mode”; and

a normal tuning mode portion 50 which defines the operation of the microcontroller 18 when in “normal tuning mode”; the microcontroller 18 can be toggled between event mode and normal tuning mode by the user as will be described in greater detail below.

The flow diagram employs four parameters as follows that are stored in the volatile memory of the microcontroller 18:
c the current event radio channel number, which in the example is in the range 1 to 8;
e the current event radio frequency, which is given by the lookup table 44 from the event radio channel number c;
s the current normal tuning frequency, which in the example is in the range 87.5 MHz to 108.0 MHz; and
r the frequency to which the radio receiver and amplifier circuit 14 is to be tuned, which is either the current event radio frequency e when in event mode, or the current normal tuning frequency s when in normal tuning mode.

In the initialisation portion 46 of the flow diagram of FIG. 4, when the receiver 10 is first switched on, the current event radio channel number c is set to “1” in step 52 and the current normal tuning frequency s is set to 87.5 MHz in step 54. The flow then enters the event mode portion 48.

In the event mode portion 48 of the flow diagram of FIG. 4, the lookup table 44 is used, in step 56, to look-up the current event radio frequency e for the current event radio channel number c. The reception frequency r is then set, in step 58, equal to the current event radio frequency e so that the circuit 14 tunes to that frequency. The display 24 is also set, in step 60, to display “E”c, for example “E1”. The microcontroller 18 then tests, in step 62, whether the buttons of both switches 20,22 are being pressed, and if so, in step 64, whether they have both been pressed for 3 seconds. If so, the flow moves to the normal tuning mode portion 50. However, if either test 62,64 is negative, the microcontroller 18 then tests, in step 66, whether the button of the up switch 20 is being pressed. If so, in steps 68,70, the current event radio channel number c is incremented (or if it is “8”, it is changed to “0”), and then the flow returns to step 56. If not, the microcontroller 18 then tests, in step 72, whether the button of the down switch 22 is being pressed. If so, in steps 74,76, the current event radio channel number c is decremented (or if it is “1”, it is changed to “8”), and then the flow returns to step 56. If not, then the flow returns to step 62. It will be appreciated that, following a positive test in step 66 or 72 and changing of the current event radio channel number c in steps 68,70,74,76, the tuning of the circuit 14 and display of the current radio channel number c will be updated in the subsequent steps 56,58,60. Accordingly, the buttons of the switches 20,22 can be pressed individually to change up and down the number of the event radio channel to which the receiver 10 is tuned, and can be pressed simultaneously to change to normal tuning mode.

In the normal tuning portion 50 of the flow diagram of FIG. 4, the reception frequency r is set, in step 80, equal to the current normal tuning frequency s so that the circuit 14 tunes to that frequency. The display 24 is also set, in step 82, to display that frequency, for example “87.5”. The microcontroller 18 then tests, in step 84, whether the buttons of both switches 20,22 are being pressed, and if so, in step 86, whether they have both been pressed for 3 seconds. If so, the flow moves to the event radio mode portion 48. However, if either test 84,86 is negative, the microcontroller 18 then tests, in step 88, whether the button of the up switch 20 is being pressed. If so, the microcontroller 18 then tests, in step 90, whether the button of the up switch 20 has been pressed momentarily (e.g. for less than 0.2 seconds). If so, then in step 92, the microcontroller 18 scans the reception frequency r upwardly, displaying the current frequency as it does, until either a strong signal is received or the reception frequency r reaches 108.0 MHz. If not, then in step 94, the microcontroller 18 steps the reception frequency r upwardly in 0.1 MHz steps, displaying the current frequency as it does, until either the button of the up switch 20 is released or the reception frequency r reaches 108.0 MHz. If, in step 88, it is determined that the button of the up switch 20 is not being pressed, the microcontroller 18 then tests, in step 96, whether the button of the down switch 22 is being pressed. If so, the microcontroller 18 then tests, in step 98, whether the button of the down switch 22 has been pressed momentarily (e.g. for less than 0.2 seconds). If so, then in step 100, the microcontroller 18 scans the reception frequency r downwardly, displaying the current frequency as it does, until either a strong signal is received or the reception frequency r reaches 87.5 MHz. If not, then in step 102, the microcontroller 18 steps the reception frequency r downwardly in 0.1 MHz steps, displaying the current frequency as it does, until either the button of the down switch 22 is released or the reception frequency r reaches 87.5 MHz. After step 92, 94, 100 or 102, the normal tuning frequency s is set in step 104 equal to the current reception frequency r and the flow then returns to step 84. If the test of step 96 is negative, the flow also returns to step 84. Accordingly, like some conventional radio receivers, the buttons of the switches 20,22 can be pressed individually to cause the receiver 10 to scan upwardly or downwardly in the 87.5 to 108.0 MHz band for the next strong signal, or to cause the receiver 10 to step upwardly or downwardly in the 87.5 to 108.0 MHz band in 0.1 MHz steps. However, unlike a conventional radio receiver, the buttons of the switches 20,22 can be pressed simultaneously to change to event radio mode.

It should also be noted that, upon a return to the event radio mode 48, the receiver 10 tunes to the event radio channel c to which it was last tuned when in event radio mode, and, upon a return to the normal tuning mode 50, the receiver 10 tunes to the frequency s of the radio station to which it was last tuned when in normal tuning mode. It should furthermore be noted that, when the receiver 10 is initially turned on, it is initially tuned as a result of steps 52,56,58 to the first frequency listed in the lookup table 44 (75.9 MHz in the example given). In the case where the receiver 10 is supplied for use at a particular event for which event radio is to be broadcast on a particular frequency, that frequency may be stored as the first frequency in the lookup table 44 so that when the receiver 10 is initially switched on it automatically tunes to the relevant event radio broadcast.

Although the frequencies e listed in the lookup table 44 in FIG. 4 are all outside the 87.5 to 108.0 MHz band, it will be appreciated that some of the event radio frequencies e may be within the 87.5 to 108.0 MHz band.

FIG. 5 shows a modification to the flow diagram of FIG. 4 in which provision is made for only one event radio channel which is outside of the 87.5 to 108.0 MHz band. Accordingly, the lookup table 44 contains only one entry of an event radio frequency e. In the initialisation portion, in step 52, the event radio frequency e is looked up from the lookup table 44. In step 60, the display that is provided is merely “E”. Steps 56, 58 and 66 to 76 are omitted. In the event that the test of step 62 or 64 is negative, the flow returns to step 62. Otherwise the flow is similar to that described above with reference to FIG. 4.

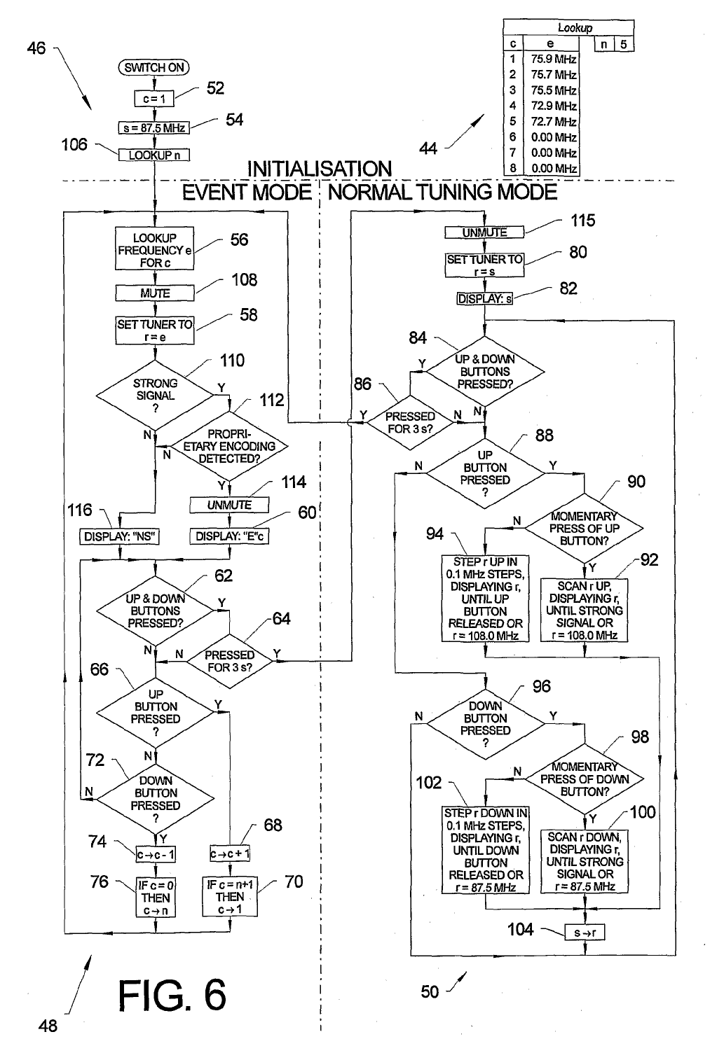

FIG. 6 shows a further modification to the flow diagram of FIG. 4 that provides the following features:

less than the maximum number of event radio frequencies e may be stored, and the receiver 10 does not attempt to tune to event radio transmissions for which no frequency has been stored;

the receiver 10 is muted if the received signal strength for an event radio frequency to which the receiver 10 is tuned does not exceed a threshold; and

the receiver 10 is muted if the received event radio signal does not include a particular code, which may, for example, be specific to a particular event radio broadcaster, so that the receiver 10 cannot be used to listen to broadcasts by other event radio broadcasters.

Specifically, the non-volatile memory 44 also stores a parameter n indicative of the number of event radio channels c that are stored in the lookup table 44 and intended to be usable. In the initialisation portion 46 of the flow diagram of FIG. 6, an additional step 106 is included, after step 54, in which the number of channels n is looked up. In the event mode portion 48 of the flow diagram, the step 76 is modified so that if the channel number c is decremented from “1”, it is changed to n, rather than “8”. Also, the step 70 is modified so that if the channel number c is incremented to n+1, rather than “9”, it is changed to “1”.

Furthermore, in the event radio portion 46 of the flow diagram, the additional step 108 is added, before step 58, in which the receiver 10 is muted before it is tuned to a different frequency r. Then, after step 58, two additional steps 110,112 are added. In step 110, it is determined whether the strength of the received signal exceeds a predetermined threshold. In step 112, it is determined whether the received radio signal includes a particular code. The encoding may be added to a subcarrier tone for example as RDS data. If the tests in steps 110,112 are both passed, then in step 114, the receiver 10 is unmuted, and then the process proceeds to steps 60,62 as in FIG. 4. However, in FIG. 6, if either of the tests in steps 110,112 is failed, in step 116 an error message such as “NS” meaning “no service” is displayed, and then the process proceeds to step 62 with the receiver 10 still muted. As before, in steps 62 to 76, the receiver 10 awaits the pressing of the up and/or down buttons. In the normal tuning mode portion 50 of the flow diagram, an initial step 115 is added to ensure that the receiver 10 is not muted at the beginning of the normal tuning mode process.

Various modifications and developments may be made to the first embodiment of receiver 10 described above. For example, although when in normal tuning mode 50, provision is made for both scan tuning (steps 92,100) and step tuning (steps 94,102) in the embodiment described above, only one of these forms of tuning may alternatively be provided.

The second embodiment of radio receiver 10 will now be described with reference to FIGS. 7 to 12. It is identical to the receiver 10 described above with reference to FIGS. 1 to 6, except in the manner in which the antenna 30 is connected to the receiver 10. The antenna 30 of FIGS. 7 to 12 forms part of a lanyard 116, as described in patent document GB2381397A, but with the additional feature that the lanyard 116 and antenna 30 assembly 118 can be removed from the receiver 10 and replaced by a different assembly 118.

Specifically, the lanyard 116 comprises a flattened sleeve 119 of flexible woven material, both ends of which are bonded into a recess 120 in a moulded plastics body of a connector plug 122. A pair of oppositely-facing claws 124 extend from the plug 122 facing away from the recess 120. A hollow metal pin 126 is moulded into the plug 122 and projects therefrom between the claws 124. The antenna 30 comprises a flexible wire 128 having one end 130 that is electrically connected inside the pin 126. The antenna wire 128 extends into one end of the sleeve 119 and through the sleeve 119 for about half of its length. The exterior of the sleeve 119 may be printed or interwoven with advertising material 132.

The connector plug 122 is arranged to be releasably connected mechanically and electrically with a complementary socket 134 in the lower edge of the receiver housing 12. The socket 134 is formed as a generally-rectangular recess 136 with claw formations 138 on one pair of opposite sides thereof. A pair of contact blades 140 are disposed against the other pair of opposite sides of the recess 136. The contact blades 140 are electrically interconnected and connected to the antenna input of the radio receiver and amplifier circuit 14.

The plug 122 and socket 134 are arranged so that the plug 122 can be pushed into the socket 134, and so that when the plug 122 is home, each claw 124 of the plug 122 engages with a respective claw formation 138 to lock the plug 122 in the socket 134, and the contact blades 140 connect to the plug pin 126 so that the antenna wire 128 becomes electrically connected to the antenna input of the radio receiver and amplifier circuit 14. In order to remove the assembly 118 from the receiver 10, the claws 124 are manually squeezed together, and to facilitate this the claws 124 may have protrusions 142 that can be squeezed together by a pair of pliers or a special tool. The plug 122 can then be withdrawn from the socket 134. If desired, a different lanyard and antenna assembly 118 can then be connected to the receiver 10, for example an assembly bearing different advertising material 132.

It should be noted that the embodiments of the invention have been described above purely by way of example and that many other modifications and developments may be made thereto within the scope of the present invention.

1. A radio receiver (10) having means (20,22) operable by a user to change the reception frequency (r) to which the receiver is tuned and having first and second modes (50,48) of operation, selectable by the user, wherein, at least immediately after the first mode (50) is selected, the frequency changing means is operable in a particular way by the user to tune the receiver to any desired frequency in a first band of reception frequencies and/or to the frequency of any desired signal being received in the first band of frequencies; and wherein, at least immediately after the second mode (48) is selected, either:
the receiver is tuned to a preset frequency (e) outside of the first band and operation of the frequency changing means in the particular way is ineffective,
or
the frequency changing means is operable in the particular way to tune the receiver only to any one of a plurality of preset frequencies (44) at least one of which is outside of the first band.

2. A radio receiver as claimed in claim 1, wherein, at least immediately after the second mode (48) is selected, the receiver is tuned to the preset frequency (e) outside of the first band and operation of the frequency changing means in the particular way is ineffective, and when the second mode is selected, the receiver cannot be tuned by the user to any frequency other than the preset frequency.

3. (canceled)

4. A radio receiver as claimed in claim 1, wherein, at least immediately after the second mode (48) is selected, the frequency changing means is operable in the particular way to tune the receiver only to any one of the plurality of preset frequencies (44) at least one of which is outside of the first band, and when the second mode is selected, the receiver cannot be tuned by the user to any frequency other than one of the plurality of preset frequencies.

5. A radio receiver as claimed in claim 1, wherein, at least immediately after the second mode (48) is selected, the frequency changing means is operable in the particular way to tune the receiver only to any one of the plurality of preset frequencies (44) at least one of which is outside of the first band, and, when the second mode is selected, the receiver cannot be tuned by the user to at least one of the preset frequencies in accordance with an indication stored by the receiver.

6. A radio receiver as claimed in claim 4, wherein the frequency changing means comprises first and second elements (20,22) operable by the user, wherein:
the first element (20) is operable when the first mode (50) is selected to increase the reception frequency in the first band;
the second element (22) is operable when the first mode (50) is selected to decrease the reception frequency in the first band;
the first element (20) is operable when the second mode (48) is selected to change the selection of preset frequency in one way; and
the second element (22) is operable when the second mode (48) is selected to change the selection of preset frequency in a different way.

7. A radio receiver as claimed in claim 6, wherein the selected mode can changed by the user by operating both elements simultaneously.

8. A radio receiver as claimed in claim 1, and arranged so that, when the receiver is initially switched on, the second mode is initially selected.

9. A radio receiver as claimed in claim 8, wherein, at least immediately after the second mode (48) is selected, the frequency changing means is operable in the particular way to tune the receiver only to any one of the plurality of preset frequencies (44) at least one of which is outside of the first band, and arranged so that, when the receiver is initially switched on, the receiver is initially tuned to a preset or predetermined one of the preset frequencies.

10. A radio receiver as claimed in claim 1, and arranged so that, when at least one of the modes is re-selected, the receiver is initially tuned to the frequency to which it was tuned when that mode was last selected.

11. A radio receiver as claimed in claim 1, wherein, when the second mode is selected, the receiver is operable to disable its output when a received signal has a signal strength less than a preset threshold.

12. A radio receiver as claimed in claim 1, wherein, when the second mode is selected, the receiver is operable to disable its output when a received signal does not include a particular code.

13. A radio receiver as claimed in claim 1, and which is provided by a radio receiver circuit (14) having an aerial input and a speaker output, wherein: the circuit is contained in a housing (12); a hooked element (34) extends from the housing for hanging the housing on a user's ear; a speaker (16) is contained in the housing and connected to the speaker output of the receiver circuit for directing sound at the user's ear when the housing is worn on the user's ear; a lanyard (116) extends from the housing by which the user can hold the receiver and/or hang the receiver around their neck; the lanyard forms or contains an aerial (30) connected to the aerial input of the receiver circuit; the lanyard and aerial are mechanically connected to the housing and electrically connected to the aerial input by a releasable connection (122,134) so that that lanyard and aerial can be removed from the housing and replaced by a different lanyard and aerial.

14. A radio receiver comprising: a housing (12); a hooked element (34) extending from the housing for hanging the housing on a user's ear; a radio receiver circuit (14) contained in the housing and having an aerial input and a speaker output; a speaker (16) contained in the housing and connected to the speaker output of the receiver circuit for directing sound at the user's ear when the housing is worn on the user's ear; and a lanyard (116) extending from the housing by which the user can hold the receiver and/or hang the receiver around their neck; wherein: the lanyard forms or contains an aerial (30) connected to the aerial input of the receiver circuit; and the lanyard and aerial are mechanically connected to the housing and electrically connected to the aerial input by a releasable connection (122,134) so that that lanyard and aerial can be removed from the housing and replaced by a different lanyard and aerial.

15. A radio receiver as claimed in claim 14, in combination with a further lanyard forming or containing a further aerial and having part (122) of a releasable connection (122,134) by which the further lanyard and aerial can be mechanically connected to the housing and electrically connected to the aerial input after the first-mentioned lanyard and first-mentioned aerial have been removed from the housing.
